(19) United States
(12) Patent Application Publication
(10) Pub. No.: US 2014/0180760 A1
(43) Pub. Date: Jun. 26, 2014

(54) METHOD FOR CONTEXT-AWARE RECOMMENDATIONS BASED ON IMPLICIT USER FEEDBACK

(71) Applicant: Alexandros Karatzoglou, Madrid (ES)

(72) Inventor: Alexandros Karatzoglou, Madrid (ES)

(73) Assignee: TELEFONICA, S.A., Madrid (ES)

(21) Appl. No.: 14/005,727

(22) PCT Filed: Mar. 8, 2012
(86) PCT No.: PCT/EP2012/054042

§ 371 Date: Jan. 24, 2014

(30) Foreign Application Priority Data
Mar. 18, 2011 (ES) P201130388

(51) Int. Cl. G06Q 30/02

(52) U.S. Cl. CPC G06Q 30/0201
USPC 705/7.29

(57) ABSTRACT

Method for Context-Aware Collaborative Filtering comprising:
a) performing collaborative filtering introducing a user-item-context interaction as a definition of the data and modelling them using tensor factorization (TF);
b) generating one or more recommendations using said modelling; and
c) displaying the recommendations to a user.
   said tensor used for tensor Factorization (TF) represent indirect indications of a user's preferences for an item, meaning implicit feedback data.

### FIELD OF THE ART

The present invention generally relates to a method for context-aware collaborative-filtering, and more particularly to a method for Context-Aware recommendations based on implicit user feedback.

Recommender Systems have become ubiquitous tools to find our way in the age of information. User preferences are inferred from past consumption patterns or explicit feedback and predictions are computed by analyzing other users—Collaborative Filtering (CF)—or categorizing the items by their content—Content-based—Recommendations.

### PRIOR STATE OF THE ART

Chris Anderson in his famous book “The Long Tail” asserts that “we are leaving the age of information and entering the age of Recommendation”. Recommender Systems have become essential navigational tools for users to wade through the plethora of online content as they provide a personalized tool for information discovery. Users often rely on recommendations to locate a product, service or piece of information that they otherwise would not be able to locate by means of traditional search methods (keyword search). Recommender systems have the advantage of personalization and discovery of information while lacking the need of keywords. Recommender Systems do not only provide a complementary service to satisfy users' web-shopping needs better but are becoming valuable Information Retrieval tools that exploit the collective intelligence of crowds.

In order to improve the quality and relevance of a recommendation, it is essential to leverage all the available information. Current research in Recommender Systems, while taking into account the relation between user and item, often ignores the “context” of the recommendation. Context is a multifaceted concept that has been studied across different research disciplines [1]. In this proposal definition by Dey has been adopted: “Context is any information that can be used to characterize the situation of an entity. An entity is a person, place, or object that is considered relevant to the interaction between a user and an application.” [9]. In Recommender Systems, entity is usually a user, an item and the experience that user is evaluating. The importance of contextual information has recently been recognized and is becoming a more relevant area of research. For example, workshops on the topic were held at the last two ACM Recommender Systems Conferences. Moreover new applications (e.g. Foursquare, Sourcetone) that use contextual variables are emerging.

Much of the recent research in recommender systems has focused on predicting scores for a particular user, item interaction with higher scores reflecting a bigger probability of acceptance of the item by the user. In this setting the available data is usually represented in a sparse two-dimensional matrix in which we have very few values for some user, item pairs that must be used to compute the missing values of interest. In this setting any influence of context in the recommendation is ignored.

Early work on Context-Aware Recommender Systems (CARS) has found that contextual factors influence heavily the recommendation needs of users [5, 3, 19]. Depending on the recommendation domain several contextual variables can influence the recommendation needs (e.g. time, location, activity, weather, emotional state, social network, etc.). Context influence can be quite obvious, for example travel and vacation recommendations should take into account the time of the year, but can be also more subtle i.e. mood influencing depending on the type of music one would prefer.

In fact, determining all the context variables that influence a user's preferences in a give domain can be a very difficult task. The advent of mobile computing and smart phones has enhanced the role of context in recommendation even more as mobility allows for several new recommendation domains where context variables (e.g. location, weather, social surrounding) heavily influence the preferences of a user and the relevance of a recommendation. Furthermore, incorporating context into recommender systems of the mobile domain is even more crucial since the context of mobile users is perpetually changing [6] and, with it, the users' needs.

Most recent research in the area has been devoted to the case of recommendation based on explicit user feedback data such as ratings (e.g. Netflix prize data). However, in real recommendation domains most of the available data is actually implicit, i.e., one has only an indirect indication of a user's preferences for an item. These indications can be a click, purchase, installation of an application, etc. Implicit feedback data is easier to collect as it does not require explicit feedback by the user. Especially a mobile recommender system should favour implicit over explicit feedback to avoid this additional effort for the user due to the negative impact of task disruption [13]. Types of implicit feedback include purchase and browsing history, usage history, search patterns, or even mouse movements. Although Implicit feedback data are in some sense similar to explicit feedback data e.g. they can be represented as user, item tuples in a two-dimensional matrix format but there are some differences that make modelling implicit data a unique challenge.

The single most important difference between implicit and explicit data is that the non-observed values of the user matrix items cannot be considered to be missing values anymore. In implicit feedback data negative feedback is missing and the numerical values of the interaction between items and users (counts/number of clicks etc.) can be considered as a confidence measure of how much the user liked an item. Non-observed values in implicit feedback have no clear semantics. It is not possible to be certain as to whether the user did not considered the items or if the user choose not to interact with the items (reflecting a negative feedback). For example it is not possible to be sure if a user did not buy a certain product because he did not like it or because he was not aware of it. This is in contrast to explicit feedback data where negative feedback on items from the users rating is given. This seemingly subtle difference has severe consequences in modelling this type of data. The data provides some positive feedback in the form of the user-item interactions but negative feedback is much more difficult to define in implicit feedback data. On the other hand one cannot anymore ignore the non-observed user-item as in the case of explicit feedback as these carry potential valuable information about what the user dislikes. These non-observed user-item values represent the vast majority of the data. In other terms the sparse user-item two-dimensional matrix that represents explicit rating ceases to be sparse in the case of Implicit Feedback data. A direct consequence of this is that a simple Matrix Factorization (a standard Collaborative Filtering method e.g. [22]) would scale O(nm) where n is the number of users and m is the number of items compared to O(N) where N is the number of observed user-item rating for the explicit case making the use of this type of techniques prohibitively expensive even for modestly sized data.

Another difference between explicit and implicit feedback data is that implicit feedback data tend to be noisier. Although the existence of noise in explicit feedback data is well documented [4], implicit data are inherently noisier. One cannot be certain as to whether a purchased product was liked or was e.g. purchased as a present or was returned.

Context plays a vital role in implicit feedback data sets. When giving an explicit feedback, the user can expect that his rating will be further used for personalization. Therefore, the user could choose not to rate a book that was bought as a gift. In the systems that are based on implicit feedback the users control over the feedback is lost. The recommendation system gathers the entire user's activity and it is up to the system to decide which information is relevant to use to make recommendations and in which situation. Additional information gathered together with implicit user feedback could partially solve this issue. The system could automatically discover the context and provide relevant recommendations for the specific context. In this sense, context can bee seen as a query refinement, i.e., a CARS tries to retrieve the most relevant items for a user, given the knowledge of the context of the request.

Spurred by contests (e.g. the Netflix prize), data availability and strong commercial relevance, research in Recommender Systems has flourished with impressive results. Until recently it has mostly focused on the simple formulation of the recommendation problem which involves predicting scores for user, item pairs, in order to quantify how much a user will like an item or the probability of a purchase.

There are essentially two ways of inferring user's preferences from past consumption or usage patterns (implicit feedback) or ratings (explicit feedback) ratings [2]:

1) Collaborative Filtering (CF) where preferences are predicted by modelling the collective taste information from all users. The underlying assumption is that users who have common preferences on items chosen in the past tend to agree again in the future.

2) Content-based Recommendation where preferences are predicted by individual user (or item) modelling. The underlying assumption is that the preferences of a user can be modelled using data about the user (in particular demographic information such as age, gender, etc.) and about the product (e.g. in the case of movies, information about genre, actors, etc.).

Combinations of CF and Contend-based Recommendation (Hybrid Methods) have been proposed in the literature both to increase performance and to solve the cold start problem.

Popular and successful methods for CF include: 1) Memory based methods e.g. [10, 16], that first find similar users (or items) based on the transactions and on the ratings and then compute recommendations for a particular user as a weighted average of ratings from similar users (or items); 2) Model-based methods e.g. [7], that essentially model the interaction between users and items based on some underlying latent factors. Matrix Factorization methods are a well-known class of factor methods that have been shown to perform very well on many CF problems [22, 14, 21]. Matrix factorization methods solve the recommendation problem by decomposing the sparse user-item matrix and learning latent factors for each user and item in the data.

The role played by context has been recognized recently and has contributed to increase research efforts in the emergent area of CARS. CARS have been classified into three types according to the approach followed to integrate context [3]: 1) contextual pre-filtering, where context drives data selection; 2) contextual post-filtering, where context is used to filter recommendations once they have been computed using a traditional approach; and 3) contextual modelling, where context is integrated directly into the model. An example of contextual pre-filtering is the so-called user micro-profile, in which a single user is represented by a hierarchy of possibly overlapping contextual profiles [5]. In their experimental evaluation, Panniello et al. [19] found that the choice of a pre-filtering or post-filtering strategy depends on the particular method and sometimes a simple post-filter can outperform an elaborate pre-filtering approach.

Most of these approaches provide only limited benefits and do not adequately integrate context information into a model. In particular, in the CF setting the interactions between data (ratings/or purchases) in different context settings are ignored in the pre-filtering methods and not properly taken into account in post-filtering methods. Some CF models have been built that incorporate the temporal dimension [14], but they do not personalize the effects of the temporal variable but rather model global time effects. Recently in [12] it has been introduced a Context-Aware CF model for explicit data that is based on Tensor Factorization and outperforms state of-the-art CARS methods but this model is not adequate for the case of implicit data.

In this proposal it is presented a generic CF model that is based on a generalization of MF to address context-aware recommendation problems where only implicit user feedback is available. To this end, it has been extended the concept of matrix factorization to that of tensor factorization. A Tensor is a generalization of a matrix to multiple dimensions. In the example given above, the usual user-item two-dimensional matrix is converted into a three-dimensional tensor in the presence of context. Tensor Factorization (TF) can be used to add any number of variables to a CF-based Recommender System.

All the known literature on modelling implicit data using factor models has focused on the user-item version of the data ignoring any existing context variables. In [18] a regression-based matrix factorization technique is used together with several sampling techniques that deal with the large amount of non-observed data i.e. all observed user-item are used in the factorization together with a sample of the non-observed user-item pairs. In [20] a factorization approach based on the optimization of a smoothed pair wise ranking loss function [23] is proposed. A sampling procedure is again used in the optimization procedure in order to deal with the very large observed/non-observed pairs.

Another Matrix Factorization approach for dealing with the large amount of non-observed entries was introduced in [11]. It relies on using a simple least squares loss function and exploiting the structure of the data (dominated by zero entries signalling negative preference). The method performs well on a TV viewing dataset. A similar approach was also used in [17] and compared to sampling schemes. The model presented in this paper extends the methods used in [11] from the simple two-dimensional matrix factorization case to the N-dimensional Tensor Factorization that takes context into account.

In this document it is introduced a Context-Aware Collaborative Filtering method for Implicit data that is based on Tensor Factorization (TF).

The proposed model brings a number of contributions to the area of context-aware recommendations, including the ability to:
Generalize efficient MF approaches to the Context-Aware case in a compact way
Include any number of contextual variables into the model itself
Use Implicit Feedback data to produce recommendations
Train the model with a fast and straightforward algorithm that scales linear to the number of available implicit data.
Take advantage of the structure of the data while still exploiting the interaction between all users-items and context.

### DESCRIPTION OF THE INVENTION

The present invention provides a method for context-aware collaborative filtering comprising following steps:
a) performing collaborative filtering introducing a user-item-context interaction as a definition of the data and modelling them using tensor factorization (TF);
b) generating one or more recommendations using said modelling; and
c) displaying the recommendations to a user
   wherein said tensor used for tensor Factorization (TF) represents indirect indications of a user's preferences for an item, this meaning implicit feedback data.

The implicit feedback data used are selected from a list comprising a click on the item, mouse movements, a purchase, installation of an application, browsing history, usage history, search patterns.

The tensor used has at least three dimensions, corresponding to the following available variables: user, item and at least one context variable.

In a general implementation said factorization is a N-dimensional factorization.

Concerning the referred at least one context variable it is selected from a group comprising: time, location, activity, weather, emotional state, social network.

Other features of the invention will appear in the following description related to the accompanying drawings.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the 3-dimensional tensor factorization model.

FIG. 2 shows possible events of a mobile application by time.

FIG. 3 shows the precision of the methods, according to the experimental results.

FIG. 4 shows a ranking performance of the methods measured in MAP and AUC.

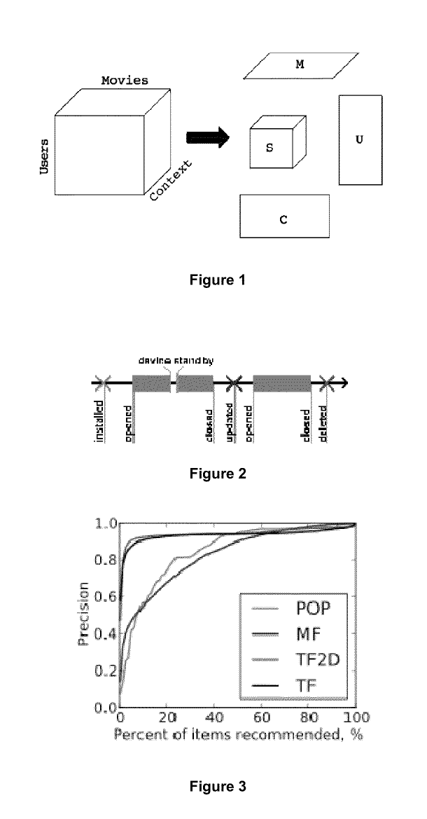

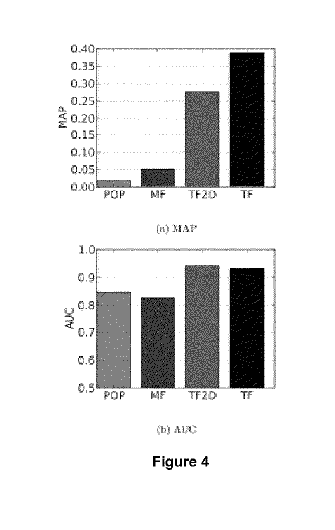

### DETAILED DESCRIPTION OF SEVERAL EMBODIMENTS

TF is an N-dimensional extension of Matrix Factorization. However, a straightforward use of this model for implicit data makes it unsuitable for the purpose of CF. In the current section Matrix and Tensor Factorization is introduced and they are explained the details of how these models to use as N-dimensional CF for implicit feedback data have been adapted. The main advantage of using TF is that the same principles that are behind Matrix Factorization in order to deal with N-dimensional information can be applied. Therefore, it provides a way to integrate additional information into the standard user-item matrix. Before diving into the details of the TF model, a briefly two-dimensional MF approach is summarized.

Matrix Factorization

CF techniques assume that the feedback provided by users on items can be represented by matrix Y ∈ Y_{n×m} (where n is the number of users and m the number of items). The observed values in Y are thus formed by the rating information provided by the users on the items. The CF problem then boils down to a Matrix Completion problem. In MF techniques the aim is to factorize the matrix of observed ratings into two matrices U ∈ R_{n×d} and M ∈ R_{m×d} such that F:=UM^{T} approximates Y, i.e. minimizes a loss function L(F,Y) between observed and predicted values. In most cases, a regularization term for better generalization performance is added to the loss function and thus the objective function becomes L(F, Y)+Ω(F).

Standard choices for L include the least squares loss function

$$L ( F , Y ) = \frac{1}{2} {( F - Y )}^{2}$$

and the Frobenius norm for Ω, i.e. Ω(F)=λ[∥U∥²_{Frob}+∥M∥²_{Frob}]

Tensor Factorization

N-dimensional TF is a generic model framework for recommendations that is able to handle N-dimensional data. It profits from most of the advantages of MF, such as fast prediction computations and efficient optimization techniques.

For the sake of simplicity, it will be described the model for a single contextual variable C, and therefore the tensor Y containing the ratings will be a 3-dimensional tensor. The generalization to larger numbers of context variables and N dimensions is trivial. In the following it is denoted the tensor of count observations by Y ∈ Y_{n×m×c}, where n are the number of users, m the number of items, and c the number of contextual variables where cᵢ ∈ {1, . . . , c}. Typically, counts are represented in integer values scale and thus Y ∈N_{n×m×c}, where the value 0 indicates that a user did not purchase/interact with an item. In this sense, 0 is special since it does not necessarily indicate that a user dislikes an item but rather that there was no interaction. Finally, the entries of the ith row of matrix U are denoted by U_{i′}.

The Candecomp-Parafac (CP) model, is a tensor decomposition model where e.g. an 3-dimensional tensor Y is decomposed into three matrices U ∈ R_{n×d}, M ∈ R_{m×d} and C ∈ R_{c×d} and the decision function for a user i, item j, context k is given by

$${F}_{ijk} = 〈 {U}_{{i}^{*}} , {M}_{{j}^{*}} , {C}_{{k}^{*}} 〉 = {\sum }_{l = 1}^{d} {U}_{il} {M}_{jl} {C}_{kl}$$

The main advantage of the CP decomposition model is its simplicity and the lack of the central tensor in the decomposed factors which allows for linear scalability. The TF method described in the remainder of the paper is based on the CP model.

The aim in proposing an N-dimensional TF approach for context-based recommendation is to model the context variables in the same way as the users and items are modelled in MF techniques by taking the interactions between users-items-context into account.

Existing Tensor decomposition methods (e.g. [15]) require a dense matrix Y and therefore ignore the sparsity of the input data. Treating Y as a dense tensor with missing entries being assumed to be 0, would introduce a bias against unobserved ratings. The model of Regularized TF introduced in this section avoids these issues by optimizing only the observed values in the rating tensor. Also note that, in contrast to standard SVD and Tensor Factorization methods, in CF there is no need to impose orthogonality constrains on the factors.

Tensor Factorization methods for CF have a number of advantages compared to many of the current context-based methods, including: (1) No need for pre- or post-filtering: In contrast to many of the current algorithms which rely on splitting and pre- or post-filtering the data based on context, TF utilizes all the available implicit feedback (counts) to model the users and the items. Splitting or pre- or postfiltering the data based on the context can lead to loss of information about the interactions between the different context settings. (2) Computational simplicity: Many of the proposed methods rely on a sequence of techniques which often prove to be computationally expensive rather than on a single and less computationally expensive model, as it is the case in TF. (3) Ability to handle N-dimensions: Moreover, the TF approach introduced in this document generalizes well to an arbitrary amount of context variables while adding relatively little computational overhead. (4) Uses Implicit Data: Most current CARS methods rely on explicit data to provide recommendations and cannot handle Implicit Feedback data.

TF Model

It will be described the model with a single additional context variable C, that is the data will be stored in a 3-dimensional tensor. Note that each dimension is treated in a same manner. Therefore, there is one dimension for each variable available (in such a way that users and items can also be considered as part of the context), for instance it would be had a 4-dimensional tensor for two additional context variables C1, C2. Generalization to more context dimensions and higher-dimensional tensors is straightforward.

Factor models for explicit ratings only use the given ratings of user-item pairs and treat non-observed values as missing data that are ignored. Thus computational complexity in most of these models (e.g. Matrix Factorization) is about linear to the number of given ratings. As stated it will no be followed the same strategy in implicit data since non-observed interaction serves as a form of implicit negative feedback. In our model observed user-item interactions are signalled with ‘1’ and unobserved with ‘0’:

$${p}_{ijk} = \{ \begin{matrix}1 & {Y}_{ijk} > 0 \\ 0 & {Y}_{ijk} = 0\end{matrix}$$

where Yᵢⱼₖ are the interaction counts between the user i, item j under context k as a user often interacts several times with the same item, e.g. watch the same show on TV or click on a news article or use an application. In contrast to the explicit feedback case it is only possible to have varying degrees of confidence to the different pᵢⱼₖ values. In particular the confidence in the negative feedback 0 values is particularly low as it is highly unlikely that a user considered all available items. These counts are considered to reflect the confidence achieved in the feedback from the user i.e. an item that is repeatedly used/consumed should reflect a greater confidence in the preferences of the user than an item that is used/consumed only once. The counts of usage of an item to “confidence” are transformed by introducing a new variable wᵢⱼₖ given by:

$${w}_{ijk} = α log ( 1 + {Y}_{ijk} ) + log ( 1 + \frac{m}{{m}_{i} + 1} )$$

where mᵢ is the number of items used by user i and α a parameter set to 10 for all our experiments. The first term in the equation reflects the confidence regarding items that are often being consumed while the second term reflects the fact that confidence in items should be high if only very few items are used.

The aim of the model is to compute the factors for the user U_{n×d}, item M_{m×d} and context C_{c×d} matrices out of the data. Once the factors have been calculated a prediction can be computed using the CP decomposition model (explained above). A higher score would reflect a high confidence that a user might like an item under the given context. Essentially it is learned a latent representation of the users, items and context variables where each user, item and context is mapped into a d dimensional vector. In the proposed Tensor Factorization model these factors are computed by minimizing the following objective function:

$${min}_{U , M , C} {\sum }_{i}^{n} {\sum }_{j}^{m} {\sum }_{k}^{c} [ {{w}_{ijk} ( {p}_{ijk} - 〈 {U}_{i *} {M}_{j *} {C}_{k *} 〉 )}^{2} + \frac{λ}{n} {‖ {U}_{i *} ‖}^{2} + \frac{λ}{m} {‖ {M}_{j *} ‖}^{2} + \frac{λ}{c} {‖ {C}_{k *} ‖}^{2} ]$$

The term

$$\frac{λ}{n} {‖ {U}_{{i}^{*}} ‖}^{2} + \frac{λ}{m} {‖ {M}_{{j}^{*}} ‖}^{2} + \frac{λ}{c} {‖ {C}_{{k}^{*}} ‖}^{2}$$

is required for regularization. Note that the regularization parameter is scaled with the dimensionality of each factor matrix. This is particularly important in the case of Tensor Factorization for Context-Aware Collaborative Filtering since typically the context factor matrix C is much smaller than the factor matrices U and M since there are usually less contextual states (e.g. time of the day, state of the weather, activity) than users or items in the dataset. Thus the contribution of the Frobenius norm of the factor matrices needs to be scaled. The actual value of the λ parameter can be found using tuning techniques and cross-validation.

In order to optimize the objective function it is necessary to deal with the n×m×c entries of the tensor Y. This is in contrast to the explicit data case where even simple optimization methods scale with the number of available ratings. Optimizing the objective function for Tensor Factorization 4 with a simple stochastic gradient descent (SGD) would severely limit the size of the datasets that it would be possible to handle with this method. Typically m and n are in the order of thousands while there can be several context dimensions.

Optimization

The objective function for Tensor Factorization 4 is optimized using Alternating Least Squares. When trying to optimize over a single factor matrix while keeping the remaining factor matrices fixed it was observed that the cost function becomes quadratic and that there is an analytic solution. As already mentioned, using a simple optimization procedure leads to unacceptable scaling behaviour, in this document it will thus try to be exploited the structure of the problem in that the zero entries of the tensor dominate the data. It is shown how to optimize the objective with respect to the user factor matrix U. The objective function is differentiated and set the derivative to zero. Solving with respect to a single user i factor vector gives:

$${U}_{i *} = {( {\sum }_{j}^{m} {\sum }_{k}^{c} {[ {M}_{j *} ⊙ {C}_{k *} ]}^{T} {w}_{ijk} [ {M}_{j *} ⊙ {C}_{k *} ] + \frac{λ}{n} I )}^{- 1} \times {\sum }_{j}^{m} {\sum }_{k}^{c} {[ {M}_{j *} ⊙ {C}_{k *} ]}^{T} {w}_{ijk} {p}_{ijk}$$

where ⊙ is the Hadamar or element-wise product and I the identity matrix of size d. Directly computing this expression would scale O((nc)²d) which would be prohibitively expensive even for relatively small datasets. A very significant speedup can be achieved by rewriting this expression as:

$${\sum }_{j}^{m} {\sum }_{k}^{c} {[ {M}_{j *} ⊙ {C}_{k *} ]}^{T} {w}_{ijk} [ {M}_{j *} ⊙ {C}_{k *} ] = {\sum }_{j}^{m} {\sum }_{k}^{c} {[ {M}_{j *} ⊙ {C}_{k *} ]}^{T} [ {M}_{j *} ⊙ {C}_{k *} ] + {\sum }_{j}^{m} {\sum }_{k}^{c} {[ {M}_{j *} ⊙ {C}_{k *} ]}^{T} ( {w}_{ijk} - 1 ) [ {M}_{j *} ⊙ {C}_{k *} ]$$

The first part Σⱼ^{m}Σₖ^{c}[Mⱼ* ⊙ Cₖ*]^{T}[Mⱼ* ⊙ Cₖ*] is now independent of the user and can be pre-computed at the beginning of the iteration over each user factor matrix.

In the second part Σⱼ^{m}Σₖ^{c}[Mⱼ* ⊙ Cₖ*]^{T}(wᵢⱼₖ−1)[Mⱼ* ⊙ Cₖ*] the expression (wᵢⱼₖ−1) is 0 for all the non-observed values in the tensor Y which are the vast majority of entries in the Tensor and it thus can be computed over the non-zero values Sᵢ^{U+} of user i in the Tensor Y. This vastly improves computation time and scalability to O((d)²nᵢ^{U+}+d³) assuming cubic scalability for the matrix inversion. Note that more scalable matrix inversion techniques but would provide limited benefits in this case since the dimension of d is typically small 10-40. This expression cam be rewrote as:

$${\sum }_{j}^{m} {\sum }_{k}^{c} {[ {M}_{j *} ⊙ {C}_{k *} ]}^{T} {w}_{ijk} [ {M}_{j *} ⊙ {C}_{k *} ] = {\sum }_{j}^{m} {\sum }_{k}^{c} {[ {M}_{j *} ⊙ {C}_{k *} ]}^{T} [ {M}_{j *} ⊙ {C}_{k *} ] + {\sum }_{j , k ∈ {S}_{I}^{U} +} {[ {M}_{j *} ⊙ {C}_{k *} ]}^{T} ( {w}_{ijk} - 1 ) [ {M}_{j *} ⊙ {C}_{k *} ]$$

where Sᵢ^{U+} the set of non-zero values of the tensor of user i in tensor Y. Since it is necessary to compute this over each user the scalability becomes O(d²N+d³n). Note also that

$${\sum }_{j}^{m} {\sum }_{k}^{c} {[ {M}_{j *} ⊙ {C}_{k *} ]}^{T} [ {M}_{j *} ⊙ {C}_{k *} ] = {M}^{T} M ⊙ {C}^{T} C$$

which can be used to speed up computations since matrix libraries handle this type of computations efficiently.

Once the user factors U are computed it is possible to compute the item M and context factors C in a similar manner. The item factors for a given item j can be computed for an item factor using:

$${M}_{j *} = {( {\sum }_{i}^{n} {\sum }_{k}^{c} {[ {U}_{i *} ⊙ {C}_{k *} ]}^{T} {w}_{ijk} [ {U}_{j *} ⊙ {C}_{k *} ] + \frac{λ}{m} I )}^{- 1} \times {\sum }_{j}^{n} {\sum }_{k}^{c} {[ {U}_{i *} ⊙ {C}_{k *} ]}^{T} {w}_{ijk} {p}_{ijk}$$

The same procedure described for the user factors can be used to speed up the computations. In a similar manner the context factors are also computed. The optimization procedure is repeated over each factor matrix until convergence. They are typically run 10 iterations of the optimization procedure over the factor matrices. As described the whole procedure is linear to the number of observed data N while still optimizing over the whole n\dot{m}ċ user-item-context combinations.

Missing Context Information

Tensor Factorization also allows for an intuitive way of dealing with missing context information. Assume that there is missing the context information of user-item interaction done by user i′ on item j′ Y_{i′,j′}. Intuitively, one would like to use this data in the profile information of the user and the item while either not update the information of the context profile or applying the update equally on all context profiles. There are thus two options:
Update the U_{i′}* and M_{j′}* factors and remove the data point from the C
Update the U_{i′}* and M_{j′}* factors while updating all the context profiles in C, with a discounted weight wᵢⱼₖ.

Algorithm 1: Tensor factorization

```
Input Y, d, λ, MaxIterations
Initialize U ε [symbol]    ^{n×d}, M ε [symbol]    ^{m×d} and C ε [symbol]    ^{c×d} with small
random values.
Set
for r = 1 to MaxIterations do
  Compute B = M^{T} M ⊙ C^{T} C
  for i = 1 to n do
    $\begin{matrix}Compute {U}_{i *} = \\ {( B + {\sum }_{j , k ∈ {S}_{I}^{U} +}^{n} {[ {M}_{j *} ⊙ {C}_{k *} ]}^{T} ( {w}_{ijk} - 1 ) [ {M}_{j *} ⊙ {C}_{k *} ] + \frac{λ}{n} I )}^{- 1} \\ {\sum }_{j}^{n} {\sum }_{k}^{c} {[ {M}_{j *} ⊙ {C}_{k *} ]}^{T} {w}_{ijk} {p}_{ijk}\end{matrix}$
  end for
  Compute B = U^{T} U ⊙ C^{T} C
  for j = 1 to m do
    $\begin{matrix}Compute {M}_{j *} = \\ {( B + {\sum }_{i , k ∈ {S}_{I}^{M} +}^{m} {[ {U}_{i *} ⊙ {C}_{k *} ]}^{T} ( {w}_{ijk} - 1 ) [ {U}_{i *} ⊙ {C}_{k *} ] + \frac{λ}{m} I )}^{- 1} \\ {\sum }_{j}^{m} {\sum }_{k}^{c} {[ {U}_{j *} ⊙ {C}_{k *} ]}^{T} {w}_{ijk} {p}_{ijk}\end{matrix}$
  end for
  Compute B = U^{T} U ⊙ M^{T} M
  for k = 1 to c do
    $\begin{matrix}Compute {C}_{k *} = \\ {( B + {\sum }_{i , k ∈ {S}_{I}^{C} +}^{c} {[ {U}_{i *} ⊙ {M}_{j *} ]}^{T} ( {w}_{ijk} - 1 ) [ {U}_{i *} ⊙ {M}_{j *} ] + \frac{λ}{c} I )}^{- 1} \\ {\sum }_{i}^{n} {\sum }_{j}^{m} {[ {U}_{j *} ⊙ {M}_{j *} ]}^{T} {w}_{ijk} {p}_{ijk}\end{matrix}$
  end for
end for
Output U, M, C
```

Experimental Results

This section provides the experimental evaluation of the proposed Tensor Factorization based Context-Aware Collaborative Filtering algorithm. It is analyzed the impact of using contextual information by comparing the algorithm to standard non-context-aware MF and a baseline method. We evaluate the algorithms on a real world dataset from the appazaar (http://www.appazaar.net) mobile application recommender system.

Before reporting the results, the experimental setup is detailed including the dataset used, the experimental protocol, and the different methods which are compared against.

The Data

In this document, data from the appazaar project is used to evaluate the algorithm. appazaar is a recommender system that suggests mobile applications to its users. It is a deployed system and available on the Android Market Store. Context-aware recommender systems are important for the domain of mobile applications since the number of applications is steadily growing and the relevance of an application strongly depends on the user's current context. At the time of writing there are more than 150,000 applications available for Android smart phones. The system traces mobile application usage in parallel with available context information as a basis for context-aware recommendations [8].

Since the context of mobile smart phone users perpetually changes the contextualized feedback cannot be queried explicitly from the user due to the negative impact of task interruption—i.e. users cannot be asked to provide a new feedback for every application every time the context changes. However, applications on mobile devices follow a certain lifecycle that can be characterized by different events. These events can be captured to gain information on a user's application usage as an implicit feedback.

The first event that appazaar observes is the installation of another application. It reveals that the user downloaded an application from the market. The user has deliberately added this new application to his device and maybe he has also paid for it. However, the installation event reveals an interest into the app and that it meets some of the user's requirements. Another event that appazaar captures is the update of an application, which can be interpreted as a sight of an enduring interest. However, since the update is sometimes done automatically by the operating system and the update frequency strongly depends on the release strategy of the app's developer, the entropy of this event is rather low and can be discounted. The last event possible to capture is the uninstall event, which expresses the opposite of the installation event: a user gets rid of an app because he does not need or want it anymore for any reasons, e.g. software bugs.

The chain of installation-, update-, and uninstallation-events can appear several times in the implied ordering. These events can already be used to model a user's interest profile and derive an implicit feedback for recommendations.

However, these events only occur a few times for each application. For some apps, there might even be only one event—the installation. On the other hand, the contextual relevance of an application cannot be deduced from these events. For instance, a user might install an application somewhere but use it in another context, e.g. an application for sightseeing. Therefore these three types of events cannot give any deep insights into the user's real application usage, thus a context-aware recommender system cannot be built based on these.

Instead, in this document it is exploited the closed and opened events of an application that appear in a higher frequency. They enable to observe the application usage on a more fine-grained level and to relate it to context information. appazaar therefore queries the mobile operating system for the most recently started app. Thereby it knows which application a user is currently interacting with—i.e. the application whose user interface is currently on top and visible to the user. This query is executed in intervals of 500 ms in a loop which is started automatically as soon as a user turns on his device. The application usage of the smart phone user can then be sampled and it can be inferred at which point in time a certain app was closed and another one was started.

It can be assumed, that a user will most likely only use those applications that provides a benefit to his current context—i.e. by implication: the currently running application is relevant to the user in the context. By observing the opened and closed-events of an app it is possible to infer at what time a certain app was useful.

In total, the appazaar dataset contains 3,260 users and 18,205 items and 3.7 million records about the usage of applications. The features that can be extracted are as follows.
User ID: A unique identifier for the user.
Item ID: A unique identifier for the application.
Moving: Whether the user was moving with walking speed (3), faster (4) or standing still (2); or this information is not available (1).
Currentplace: A heuristic whether the user is at home, at work or elsewhere. It has been set the most frequent place from 6 am to 6 pm as home (1), the most frequented place from 6 pm to 6 am as home (2), and defined all other locations as elsewhere (3).
Time of day: The time of the day in blocks of 2 hours, from 12 pm-2 am (1) to 10 pm-12 pm (12).
Day of the week: From Sunday (1) to Saturday (7).
Number of times used: The number of times which the application was used by the user with regard to the other parameters.
Total time used: The accumulated time which the application was used by the user with regard to the other parameters.

Note that there are 6 context variables (including users and apps) so the data is modelled with a 6-dimensional Tensor.

Evaluation Protocol

It has been temporally ordered the application usage (implicit data) and splitted the available data based on the time with the first 80% of the data forming the training set and the remaining 20% for testing. The implicit data was then aggregated for each contextual combination found in the data set. For example, user u used application i while standing still at home, between 6 pm to 6 am on Weekend 25 times and used it in total for 49 minutes. In order to facilitate the comparison to non-context aware methods the test set was filtered so that for each user-item combination only one context combination is in the test set. Essentially, the methods predict scores for each item for a user in a single random context. Note that user and application combination in different context could occur also in the training set. rel(k)×P@k

It has been used the Mean Average Precision (MAP) evaluation measure:

$$M A P = {\sum }_{k}^{m} \frac{rel ( k ) \times P @ k}{N}$$

where P@k the precision at k and N the number of relevant items and:

$$rel ( k ) = \{ \begin{matrix}1 & if item at position k is relevant \\ 0 & if item at position k is not relevant\end{matrix}$$

The notion of relevant item clearly depends on the underlying data. In this application domain, an item is denoted to be relevant for a user if it was open at least once. This means, that a user has used an application to solve a certain task in the observed context. Therefore, the assumption—i.e. application usage indicates the user's contextual interest—can be considered reasonable. Clearly this is a simplification of a more general approach, which could take into account usage counts and usage times in a more sophisticated way.

MAP has been computed over each user and average the result. MAP is one of the most frequently used summary measures of a ranked retrieval list and emphasizes ranking relevant items higher. It contains both recall and precision oriented aspects and is sensitive to the entire ranking. The focus has been set on ranking related evaluation measures since finding an optimal ranking of items is highly relevant. Given the limited size of the suggestion shown to the user (usually in the order of 5-10), an optimal ranking is more important than minimizing some kind of error measure such as Mean Average Error (MAE) or Root Mean Squared Error(RMSE)

It has also been used the Area Under the Curve measure (AUC) which is the ratio of the number of correct pairwise rankings vs. the number of all possible pairs. This quantity is also called the Wilcoxon-Mann-Whitney (WMW) statistic:

$$A U C = {\sum }_{i}^{{m}^{+}} {\sum }_{j}^{{m}^{-}} \frac{δ ( {F}_{i}^{+} > {F}_{j}^{-} )}{{m}^{+} {m}^{-}}$$

$$δ ( {F}_{i}^{+} > {F}_{j}^{-} ) = \{ \begin{matrix}1 & {F}_{i}^{+} > {F}_{j}^{-} \\ 0 & otherwise\end{matrix}$$

where Fᵢ⁺ the decision values for the positive points (observed interactions) and Fᵢ⁻ for the negative and m⁺ the number of positive points and m⁻ the number of negative points. Again it is computed this quantity over each user and average. The I2 norm has been used to regularise and perform tuning to determine a good value for the regularization parameter λ. Due to computational and time constrains it has only been conducted limited parameter search on all methods tested. For the TF algorithm, the regularization parameters are set. For the α parameter the value 10 is used as it has produced good results.

Five runs for each experimental setup have been conducted and the results have been averaged. The variance of the results was insignificant in the experiments so it is not reported, it did not qualitatively influence the findings and conclusions. Moreover, all differences between TF and the other methods are statistically significant.

Methods in Comparison

The method proposed (denoted TF) has been compared to the case of 2-dimensional TF (TF2D), which essentially ignores the additional context in the data but treats the 0 values of the non-observed user-item pairs as negative feedback. They have been also compared the results against a standard Matrix Factorization (MF) approach where the 0 values are ignored and a regression is performed on the pᵢⱼₖ values. Naturally, MF also ignores the contextual information. As a baseline it has been used the overall popularity of the apps for recommending items to the users (POP). The popularity is computed by averaging the usage counts for each application, over all the users and each context.

Results

The experiments started by comparing the precision of the methods varying the amount of the provided recommendations. It will be shown in the drawings a performance of the four methods while recommending increasing amount of items. Clearly, when recommendation list grows to 100% of items recommended, precision of 1 is reached. It is necessary to note that when recommending up to 40% of items, specially designed methods for implicit data outperform the non-personalized popularity and standard MF approach. This is an expected result as it confirms the analogous results obtained in [11]. Interestingly, the MF outperforms non-personalized approach while recommending up to 15% of items. At the first sight, the two specially designed methods for implicit data behave in a similar manner. In fact, at 10% cut-off TF2D performs slightly better than TF. However, at the top of the recommendation lists TF outperforms all other methods.

To make this claim clearer, it has been computed Precision@25, i.e., calculate the probability to get all the relevant items in the first 25 positions of ranked list. Note, that this is a very difficult problem, as there are more than 8K items to choose from. The results will be shown in the drawings. Clearly TF which takes into account contextual information outperforms the other methods. Interestingly, the precision of the full 6-dimensional Context-Aware TF is very high. This is a very important property for any recommender systems algorithm, specially the precision at low rank values since in real world application only a small number of items are recommended.

For further analyses the MAP and AUC measures have been computed. The results, as it will be shown in the figures, confirm the previous experiment. In fact, MAP favours high precision at lower ranks, therefore context-aware TF performs better than all other methods. Similar to the previous experiment, TF2D is second best method followed by MF and POP.

These results differ slightly for AUC measure. In these results TF2D slightly outperforms TF. Since AUC takes into account all correct pairwise rankings vs. the number of all possible pairs, it does it for all the possible ranks and is thus focusing on the global ranking of the apps. While a good global ranking performance is an interesting property for a recommendation algorithm it is not essential since most systems mainly focusing on the top list.

Conclusions

Matrix Factorization is one of the most widely used and successful approaches to Collaborative Filtering. It was recently extended to deal with implicit data. However, the two-dimensional model itself is not flexible enough to add contextual dimensions in a straightforward manner. In this document it has been presented an extension of the model to N-dimensions. The generic Tensor Factorization approach has been adapted to the Collaborative Filtering case specially tailored for implicit feedback data. It has been also devised an optimization procedure that scales linearly to the number of available data.

In the experimental results, higher accuracy in the recommendations has been obtained by taking into account contextual variables. When comparing TF to a special MF for implicit data, they have been measured gains that range up to 40% in MAP. More notably, MAP increases from 0.05 to 0.388 when using TF instead of standard MF, not tailored for implicit data. The evaluation showed that the biggest improvements in precision are get when recommending items at the top of the recommendation list.

Tensor Factorization for implicit datasets opens up a new avenue for recommender systems. In this proposal it has been provided a method that can be used in real case scenarios of easily collectable implicit data. Moreover, it has been showed that contextual information in the implicit setting can substantially improve prediction accuracy.

### ACRONYMS AND ABBREVIATIONS

AUC AREA UNDER THE CURVE

CARS CONTEXT-AWARE RECOMMENDER SYSTEMS

CF COLLABORATIVE FILTERING

CP CANDECOMP-PARAFAC

MAE MEAN AVERAGE ERROR

MAP MEAN AVERAGE PRECISION

MF MATRIX FACTORIZATION

RMSE ROOT MEAN SQUARED ERROR

SGD STOCHASTIC GRADIENT DESCENT

SVD SINGULAR VALUE DECOMPOSITION

TF TENSOR FACTORIZATION

TF2D 2-DIMENSIONAL TENSOR FACTORIZATION

WMW WILCOXON-MANN-WHITNEY

### REFERENCES

[1] G. Adomavicius, R. Sankaranarayanan, S. Sen, and A. Tuzhilin. Incorporating contextual information in recommender systems using a multidimensional approach. ACM Transactions on Information Systems, 23(1):103-145, 2005.
[2] G. Adomavicius and A. Tuzhilin. Toward the next generation of recommender systems: A survey of the state-of-the-art and possible extensions. IEEE Trans. on Knowledge and Data Engineering, 17(6):734-749, 2005.
[3] G. Adomavicius and A. Tuzhilin. Recommender Systems Handbook, chapter Context-aware Recommender Systems. Springer, 2010.
[4] X. Amatriain, J. M. Pujol, and N. Oliver. I like it . . . i like it not: Evaluating user ratings noise in recommender systems. In UMAP '09: Proceedings of the 17th International Conference on User Modeling, Adaptation, and Personalization, pages 247-258, Berlin, Heidelberg, 2009. Springer-Verlag.
[5] L. Baltrunas and X. Amatriain. Towards time-dependant recommendation based on implicit feedback. In Workshop on Context-Aware Recommender Systems (CARS 2009) in ACM Recsys 2009, 2009.
[6] L. Barnard, J. Yi, J. Jacko, and A. Sears. Capturing the effects of context on human performance in mobile computing systems. Personal and Ubiquitous Computing, 11(2):81-96, February 2007.
[7] J. Basilico and T. Hofmann. Unifying collaborative and content-based filtering. In Proc. Intl. Conf. Machine Learning, pages 65-72, New York, N.Y., 2004. ACM Press.
[8] M. Boehmer, M. Prinz, and G. Bauer. Contextualizing mobile applications for context-aware recommendation. In Adj. Proc. of Pervasive 2010, 2010.
[9] A. K. Dey. Understanding and using context. Personal Ubiquitous Comput., 5(1):4-7, February 2001.
[10] J. L. Herlocker, J. A. Konstan, A. Borchers, and J. Riedl. An algorithmic framework for performing collaborative filtering. In SIGIR '99: Proceedings of the 22nd annual international ACM SIGIR conference on Research and development in information retrieval, pages 230-237, New York, N.Y., USA, 1999. ACM.
[11] Y. Hu, Y. Koren, and C. Volinsky. Collaborative filtering for implicit feedback datasets. In ICDM '08: Proceedings of the 2008 Eighth IEEE International Conference on Data Mining, pages 263-272, Washington, D.C., USA, 2008. IEEE Computer Society.
[12] A. Karatzoglou, X. Amatriain, L. Baltrunas, and N. Oliver. Multiverse recommendation: n-dimensional tensor factorization for context-aware collaborative filtering. In RecSys '10: Proceedings of the fourth ACM conference on Recommender systems, pages 79-86, New York, N.Y., USA, 2010. ACM.
[13] A. K. Karlson, S. T. Iqbal, B. Meyers, G. Ramos, K. Lee, and J. C. Tang. Mobile taskflow in context: a screenshot study of smartphone usage. In Proc. of CHI '10, 2010.
[14] Y. Koren. Collaborative filtering with temporal dynamics. In KDD '09: Proceedings of the 15th ACM SIGKDD international conference on Knowledge discovery and data mining, pages 447-456, New York, N.Y., USA, 2009. ACM.
[15] L. D. Lathauwer, B. D. Moor, J. Vandewalle, and J. V. A multilinear singular value decomposition. SIAM. J. Matrix Anal. & Appl, 21:1253-1278, 2000.
[16] G. Linden, B. Smith, and J. York. Amazon.com recommendations: item-to-item collaborative filtering. IEEE Internet Computing, 7(1):76-80, 2003.
[17] R. Pan and M. Scholz. Mind the gaps: weighting the unknown in large-scale one-class collaborative filtering. In KDD '09: Proceedings of the 15th ACM SIGKDD international conference on Knowledge discovery and data mining, pages 667-676, New York, N.Y., USA, 2009. ACM.
[18] R. Pan, Y. Zhou, B. Cao, N. N. Liu, R. Lukose, M. Scholz, and Q. Yang. One-class collaborative filtering. In ICDM '08: Proceedings of the 2008 Eighth IEEE International Conference on Data Mining, pages 502-511, Washington, D.C., USA, 2008. IEEE Computer Society.
[19] U. Panniello, A. Tuzhilin, M. Gorgoglione, C. Palmisano, and A. Pedone. Experimental comparison of preys. post-filtering approaches in context-aware recommender systems. In RecSys '09: Proceedings of the third ACM Recommender Systems Conference, pages 265-268, 2009.
[20] S. Rendle, C. Freudenthaler, Z. Gantner, and L. Schmidt-Thieme. Bpr: Bayesian personalized ranking from implicit feedback. In UAI '09: Proceedings of the Twenty-Fifth Conference on Uncertainty in Artificial Intelligence, pages 452-461, Arlington, Va., United States, 2009. AUAI Press.
[21] N. Srebro, J. Rennie, and T. Jaakkola. Maximum-margin matrix factorization. In L. K. Saul, Y. Weiss, and L. Bottou, editors, Advances in Neural Information Processing Systems 17, Cambridge, Mass., 2005. MIT Press.
[22] G. Takacs, I. Pilaszy, B. Nemeth, and D. Tikk. Scalable collaborative filtering approaches for large recommender systems. Journal of Machine Learning Research, 10:623-656, 2009.
[23] M. Weimer, A. Karatzoglou, and A. Smola. Improving maximum margin matrix factorization. Machine Learning, 72(3), September 2008.

1. Method for Context-Aware Collaborative Filtering comprising:
a) performing collaborative filtering introducing a user-item-context interaction as a definition of the data and modelling them using tensor factorization (TF);
b) generating one or more recommendations using said modelling; and
c) displaying the recommendations to a user; and
wherein said tensor used for tensor Factorization (TF) represent indirect indications of a user's preferences for an item, meaning implicit feedback data.

2. Method, according to claim 1, wherein said implicit feedback data are selected from a list comprising a click on the item, mouse movements, a purchase, installation of an application, browsing history, usage history, search patterns.

3. Method, as per claim 1, wherein said tensor has at least, three dimensions, corresponding to the following available variables: user, item and at least one context variable.

4. Method according to claim 3, wherein said factorization is a N-dimensional factorization.

5. Method, according to claim 3, wherein said at least one context variable is selected from a group comprising: time, location, activity, weather, emotional state, social network.

6. Method, as per claim 3, wherein the values in the tensor indicate the interaction counts between the user and the item under, at least, one context variable and wherein the value 0 indicates that a user did not interact with an item.

7. Method, according to claim 6, wherein the counts of usage of an item is transformed to confidence according to the following formula
$${w}_{ijk} = α log ( 1 + {Y}_{ijk} ) + log ( 1 + \frac{m}{{m}_{i} + 1} )$$
wherein Yᵢⱼₖ is the tensor, mᵢ is the number of items used by user i and α is a parameter equal to 10.

8. Method, as per claim 1, wherein said Tensor Factorization is computed by minimizing the following objective function:
$${min}_{U , M , C} {\sum }_{i}^{n} {\sum }_{j}^{m} {\sum }_{k}^{c} [ {{w}_{ijk} ( {p}_{ijk} - 〈 {U}_{i *} {M}_{j *} {C}_{k *} 〉 )}^{2} + \frac{λ}{u} {‖ {U}_{i *} ‖}^{2} + \frac{λ}{m} {‖ {M}_{j *} ‖}^{A} + \frac{λ}{c} {‖ {C}_{k *} ‖}^{2} ]$$
wherein the term
$$\frac{λ}{n} {‖ {U}_{{i}^{*}} ‖}^{2} + \frac{λ}{m} {‖ {M}_{{j}^{*}} ‖}^{2} + \frac{λ}{c} {‖ {C}_{{k}^{*}} ‖}^{2}$$
is required for regularization.

9. Method according to claim 8, wherein said regularization term or parameter is scaled with the dimensionality of each factor matrix.

10. Method according to claim 8, wherein said λ parameter is found using tuning techniques and cross-validation.

11. Method according to claim 8, wherein said objective function is optimized using Alternating Least Squares.

12. Method as per claim 1, wherein when some context information of user item interaction is missing one of the following procedures is conducted:
not updating the information of the context profile or
not applying the update equally on all context profiles
